(19) United States
(12) Patent Application Publication
(10) Pub. No.: US 2026/0356218 A1
(43) Pub. Date: Nov. 12, 2026

(54) VEHICLE MODULE CPM OF AN INDUCTIVE CHARGING SYSTEM FOR A VEHICLE

(71) Applicant: Brusa Elektronik AG, Buchs (CH)

(72) Inventors: Veit Pfättisch, Ingolstadt (DE); Simon Islinger, München (DE)

(21) Appl. No.: 19/139,133

(22) PCT Filed: Dec. 12, 2023
(86) PCT No.: PCT/EP2023/085284

§ 371 Date: Jun. 13, 2025

(30) Foreign Application Priority Data
Dec. 20, 2022 (DE) 10 2022 134 068.6

(51) Int. Cl. B60L 53/12; B60L 53/302; H01F 27/28

(52) U.S. Cl. CPC B60L 53/12; B60L 53/302; H01F 27/28

(57) ABSTRACT

Vehicle module CPM to convert electromagnetic energy of an electromagnetic field, generated by a ground module GPM of an inductive vehicle charging system, into electric energy of an electric current to charge an electric storage device and/or operate an electrical load, the CPM including: a main coil assembly with a main coil to convert the electromagnetic field into electric alternating current AC, an electronic assembly to convert the AC into direct current DC; one or more heat tubes to transfer heat generated locally in the main coil assembly and/or the electronic assembly during the energy conversion operation, and transfer the heat from the main coil assembly to the electronic assembly and vice versa; and a channel in the electronic assembly through which a refrigerant is flowable and which is connectable to an external heat exchanger, wherein the channel is configured to transfer heat from the electronic assembly to the refrigerant.

### CROSS REFERENCE TO RELATED APPLICATIONS

The present application is the U.S. National Phase of PCT/EP2023/085284, filed on 12 Dec. 2023, which claims priority to German Patent Application No. 10 2022 134 068.6, filed on 20 Dec. 2022, the entire contents of which are incorporated herein by reference.

### BACKGROUND

### Field

The invention relates to a vehicle module CPM of an inductive charging system for a vehicle.

### Related Art

As is known, inductive charging systems for vehicles typically comprise a ground module (ground pad module; GPM) that is fixed to the ground and connected to a power grid, and a vehicle module (car pad module; CPM) that is typically arranged on the underside of a vehicle. Typically, in such inductive charging systems, energy is inductively transferred to a main coil of the vehicle module CPM arranged in the vehicle a main coil of the ground module GPM for charging an electrical storage unit/battery and/or for supplying an electrical load. The ground module GPM and the vehicle module CPM can also be configured for bidirectional energy transfer, i.e., from GPM to CPM and from CPM to GPM.

Both the GPM and the CPM typically include an electronic assembly and a main coil assembly with a main coil. In order to enable optimal electromagnetic coupling of the two main coils for energy transmission, the main coil of the GPM and the main coil of the CPM must be optimally positioned relative to each other.

During operation, i.e., during energy transfer from main coil to main coil, heat is generated in the GPM and in the CPM substantially in two regions: (a) in the respective electronic assembly, in which a lot of heat is generated relatively concentrated at certain locations with high local heat density, and (b) in the respective main coil assembly (main coil and ferrite), in which less and relatively well-distributed heat is generated relative to the electronic assembly. The electronic assembly typically comprises power electronics.

### SUMMARY

It is the object of the invention to improve heat dissipation from a vehicle module CPM of an inductive vehicle charging system.

The invention results from the features of the independent claims. Advantageous refinements and embodiments are the subject matter of the dependent claims. Other features, possible applications, and advantages of the invention will be apparent from the following description and from the discussion of example embodiments of the invention, which are depicted in the figures.

A first aspect of the invention relates to a vehicle module CPM for converting electromagnetic energy of an electromagnetic field generated by a ground module GPM of an inductive vehicle charging system into electrical energy of an electric current, and for charging an electrical storage device and/or operating an electrical load in the vehicle, wherein the vehicle module CPM comprises:
a main coil assembly having a main coil for converting the electromagnetic field into an alternating electrical current AC, and
an electronic assembly with power electronics for converting alternating electrical current AC into direct current DC.

The proposed vehicle module CPM is characterized in that one or more heat tubes are provided for transferring/distributing heat generated locally in the main coil assembly and/or in the electronic assembly during energy conversion operation, wherein the heat tubes transfer the locally generated heat from the main coil assembly to the electronic assembly and vice versa, and the electronic assembly has a channel through which a refrigerant fluid can flow, which channel can be connected to an external heat exchanger, wherein the channel is configured and designed to transfer heat from the electronic assembly to the refrigerant fluid.

Local heat generated in the vehicle module CPM during energy conversion operation in the main coil assembly and in the electronic assembly is thus transferred between the aforementioned assemblies by means of the heat tubes, so that heat is distributed substantially equally between the two assemblies. Typically, the amount of local heat generated in the electronic assembly is greater than in the main coil assembly. The channel, through which a refrigerant fluid can flow and which is in heat-conducting contact with the electronic assembly and acts as a heat sink, additionally dissipates heat from the region of the electronic assembly. Overall, on the one hand, the heat generated locally in the vehicle module by means of the heat tubes is essentially evenly distributed in the vehicle module or in its housing, and at the same time, heat is dissipated from the electronic assembly by means of the channel through which a refrigerant fluid flows. Both together enable improved cooling of the vehicle module CPM on the one hand and higher electrical power conversion in the vehicle module CPM on the other.

The term “heat tube” refers here to a heat exchanger that allows a high heat flux density by utilizing the evaporation enthalpy of a medium. In this way, large amounts of heat can be transferred over a small cross-sectional area. A basic distinction is made between two types of heat tubes: the so-called “heat tube” and the so-called “two-phase thermosiphon.” The basic operating principle is the same for both designs. The difference lies in the return transport of the gaseous working medium to the evaporator, i.e., to the point where heat is supplied. In both designs, the return transport is passive and therefore without any aids, such as a circulation pump.

The thermal resistance of a heat tube is significantly lower than that of metals at operating temperature. The behavior of the heat tubes is therefore very close to an isothermal change of state. There is an almost constant temperature along the length of the heat tube. At the same transfer capacity, significantly lighter designs are possible than with conventional heat exchangers under the same operating conditions. By carefully selecting the working medium of the heat tube, operating temperatures from a few Kelvin to approximately 3,000 Kelvin can be achieved.

The ability of a heat tube to transport energy depends largely on the specific evaporation enthalpy (in kJ/mol or kJ/kg) of the working medium and not on the thermal conductivity of the vessel wall or working medium. For efficiency reasons, a heat tube is usually operated at the warm end just above and at the cold end just below the boiling temperature of the working medium.

Advantageously, in regions of the main coil assembly and/or of the electronic assembly that have a high local heat generation during energy conversion operation, the heat tubes are arranged in a higher density (with smaller distances between directly adjacent heat transfer elements) than in regions with low local heat generation.

Advantageously, the one or the multiple heat tube(s) with a respective tube length L is/are each arranged relative to one another in such a way that directly adjacent heat tubes are spaced apart by a distance D from the range: 3<L/D<10. This indicates an optimum for the distance D of heat tubes so that a sufficient number of heat tubes is available for a largely uniform temperature distribution within the CPM.

Advantageously, at least some of the multiple heat tubes are arranged in two or more parallel planes in the vehicle module CPM. It is assumed that the heat tubes are designed in such a way that their longitudinal extension runs in one plane. They can be designed straight or curved. Advantageously, at least some of the multiple heat tubes are arranged at least in two non-parallel planes in the vehicle module CPM. Advantageously, at least some of the multiple heat tubes are arranged in two or more non-parallel planes in the vehicle module CPM.

Advantageously, at least some of the multiple heat tubes are arranged in two or more mutually parallel planes in the vehicle module CPM.

Advantageously, at least some of the multiple heat tubes are arranged at least in two non-parallel planes in the vehicle module CPM.

Advantageously, at least one heat tube or, in particular, all heat tubes are arranged in a housing material of a housing of the vehicle module CPM and/or directly on the housing of the CPM and/or at least in heat-conducting contact with the housing.

The main coil of the CPM advantageously comprises at least one coil wire arranged in a predetermined geometry as a coil wire arrangement. In particular, the main coil of the CPM is designed as a flat coil. Advantageously, the material adjacent to the main coil is a ferrimagnetic or a ferromagnetic material. Advantageously, at least one section of the at least one heat tube is arranged substantially congruently above and/or below at least one section of the coil wire. This allows heat generated in the coil wire to be transferred directly to the heat tube and distributed in the CPM by the heat tube.

If the coil wire arrangement has an increased coil wire density in at least one region of the CPM, sections of multiple of the heat tubes are advantageously arranged in this region at a higher density than in other regions of the coil wire arrangement with a low coil wire density.

Advantageously, the main coil consists of at least one coil wire, the main coil has at least one region with an increased coil wire density, wherein in this region sections of multiple of the heat tubes are arranged at a higher density than in other regions of the main coil.

Advantageously, a section of the one heat tube or respective sections of the multiple heat tubes are arranged above and/or below the coil wire arrangement in the intermediate region between individual coil wire windings.

Advantageously, the at least one coil wire of the coil wire arrangement is arranged/wound in only one coil wire plane and the at least one heat tube or the multiple heat tubes is/are arranged parallel to the coil wire plane.

Advantageously, at least one of the heat tubes is arranged along the coil wire wound around the coil wire.

Advantageously, the at least one coil wire is wound around at least a portion of the at least one heat tube.

In an advantageous embodiment, the at least one coil wire is designed as a heat tube.

Advantageously, the main coil of the main coil assembly of the CPM is embedded in a first thermally conductive material. Advantageously, power electronics of an electronic assembly of the CPM is embedded in a second thermally conductive material which is thermally conductively connected to the first thermally conductive material.

Advantageously, the housing of the CPM is made of a material with a thermal conductivity λ>100 W/(m*K), in particular >150 W/(m*K).

Advantageously, the housing of the CPM has a structured outer surface which is in thermally conductive contact with one or more of the heat tubes.

Advantageously, the main coil assembly and the electronic assembly are arranged spatially separated from one another within the vehicle module CPM, with a wall arranged between the two assemblies, which is designed as a heat-conducting element. Advantageously, the heat conducting element consists of a material with a thermal conductivity λ>10 W/(m*K) or λ>100 W/(m*K) or λ>150 W/(m*K) or λ>200 W/(m*K) or λ>300 W/(m*K). Advantageously, at least one heat tube is connected to the heat conducting element in a heat-conducting manner.

Advantageously, the main coil assembly comprises a main coil, wherein the main coil is embedded in a first thermally conductive material.

Advantageously, the electronic assembly comprises a power electronics, wherein the power electronics is embedded in a second thermally conductive material which is thermally conductively connected to the first thermally conductive material.

Advantageously, the housing of the vehicle module CPM has a structured outer surface which is in thermally conductive contact with one or more of the heat tubes. When the vehicle module is installed on the vehicle, the outer surface advantageously faces downwards and is advantageously freely exposed to the flow of ambient air.

A second aspect of the invention relates to an inductive charging system for a vehicle for charging an electrical storage device of the vehicle, with at least one ground module GPM and one vehicle module CPM, wherein energy is transferred at least from the ground module GPM to the vehicle module CPM and wherein the vehicle module CPM is designed as described above.

A third aspect of the invention relates to a vehicle with a vehicle module CPM as described above.

Further advantages, features, and details will be apparent from the following description, in which—optionally with reference to the drawing-at least one example embodiment is described in detail. Identical, similar, and/or functionally identical parts are provided with the same reference numerals.

### BRIEF DESCRIPTION OF THE DRAWINGS

In the drawings:

FIG. 1 shows a schematic representation of a vehicle module CPM according to the invention.

### DETAILED DESCRIPTION

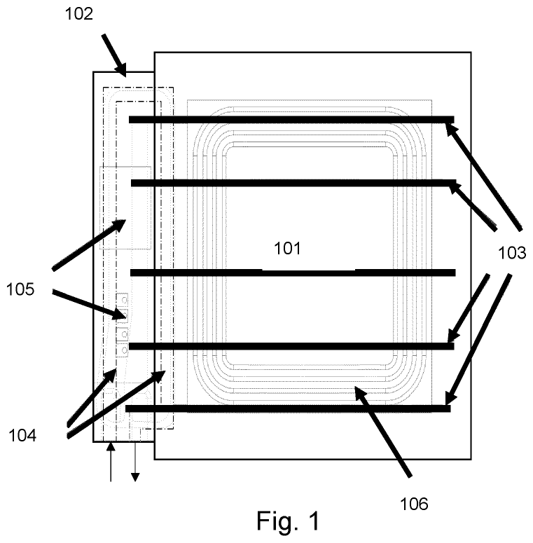

FIG. 1 shows a schematic representation of a vehicle module CPM according to the invention for converting electromagnetic energy of an electromagnetic field generated by a ground module GPM of an inductive vehicle charging system into electrical energy of an electric current and for charging an electrical storage device and/or for operating an electrical load in the vehicle. The vehicle module CPM comprises a main coil assembly 101 with a main coil 106 for converting the electromagnetic field into an alternating electrical current AC, and an electronic assembly 102 with power electronics 105 for converting the alternating electrical current AC into direct current DC.

The vehicle module CPM comprises here five heat tubes 103 arranged above the main coil for transferring/distributing heat generated locally in the main coil assembly 101 and/or in the electronic assembly 102 during energy conversion operation, wherein the heat tubes 103 transfer the locally generated heat from the main coil assembly 101 to the electronic assembly 102 and vice versa.

The electronic assembly 102 has a channel 104 through which a refrigerant fluid can flow and which can be connected to an external heat exchanger, wherein the channel 104 is configured and designed to essentially transfer heat from the electronic assembly 102 to the refrigerant fluid and thus to discharge it.

The refrigerant fluid flows through the channel 104, as indicated by the associated arrows.

Although the invention has been further illustrated and described in detail by way of preferred example embodiments, the invention is not limited by the disclosed examples, and other variations can be derived therefrom by a person skilled in the art without departing from the scope of the invention. It is therefore clear that a variety of possible variations exists. It is also clear that exemplified embodiments are really only examples, which are not to be construed in any way as limiting the scope, applicability, or configuration of the invention. Rather, the foregoing description and description of the figures enable a person skilled in the art to implement the example embodiments, and such person may make various changes knowing the disclosed inventive concept, for example with respect to the function or arrangement of individual elements cited in an example embodiment, without departing from the scope as defined by the claims and their legal equivalents, such as a more extensive explanation in the description.

### LIST OF REFERENCE NUMERALS

101 main coil assembly
102 electronic assembly
103 heat tube(s)
104 channel
105 power electronics
106 main coil

1. A vehicle module CPM to convert electromagnetic energy of an electromagnetic field generated by a ground module GPM of an inductive vehicle charging system into electric energy of an electric current, and to charge an electrical storage device and/or to operate an electrical load in the vehicle, wherein the vehicle module CPM comprises:
a main coil assembly having a main coil to convert the electromagnetic field into an alternating electrical current AC;
an electronic assembly with power electronics to convert the alternating electrical current AC into direct current DC;
one or more heat tubes to transfer or distribute heat generated locally in the main coil assembly and/or in the electronic assembly during energy conversion operation, wherein the heat tubes transfer the heat generated locally from the main coil assembly to the electronic assembly and vice versa; and
a channel provided in the ecteronic assembly through which a refrigerant fluid is flowable and which is connectable to an external heat exchanger, wherein the channel is configured to transfer heat from the electronic assembly to the refrigerant fluid.

2. The vehicle module CPM according to claim 1, wherein in first regions of the main coil assembly and/or the electronic assembly, which have a high local heat generation during the energy conversion operation, the heat tubes are arranged at a first density, and wherein in second regions of the main coil assembly and/or the electronic assembly, which have a low local heat generation during the energy conversion operation, the heat tubes are arranged at a second density, wherein the first density is higher than the second density.

3. The vehicle module CPM according to claim 1, wherein at least some of the multiple heat tubes are arranged in two or more parallel planes in the vehicle module CPM.

4. The vehicle module CPM according to claim 1, wherein at least one heat tube is arranged in a housing material of a housing of the vehicle module CPM or is arranged directly on the housing.

5. The vehicle module CPM according to claim 1, wherein the main coil assembly and the electronic assembly are arranged spatially separated from one another within the vehicle module CPM and a wall which is designed as a heat-conducting element is arranged between the two assemblies.

6. The vehicle module CPM according to claim 5, wherein the heat-conducting element consists of a material with a thermal conductivity of λ>10 W/(m*K), λ>100 W/(m*K), λ>150 W/(m*K), λ>200 W/(m*K), or λ>300 W/(m*K).

7. The vehicle module CPM according to claim 1, wherein the main coil is embedded in a first thermally conductive material, the power electronics is embedded in a second thermally conductive material thermally conductively connected to the first thermally conductive material.

8. The vehicle module CPM according to claim 1, wherein a housing of the vehicle module CPM has a structured outer surface in thermally conductive contact with one or more of the heat tubes.

9. An inductive charging system for a vehicle for charging an electrical storage device of the vehicle with at least one ground module GPM and one vehicle module CPM, wherein energy is transferred at least from the ground module GPM to the vehicle module CPM and wherein the vehicle module CPM is designed according to claim 1.

10. A vehicle with a vehicle module CPM according to claim 1.
